(19) United States
(12) Patent Application Publication
(10) Pub. No.: US 2009/0205792 A1
(43) Pub. Date: Aug. 20, 2009

(54) ROLLER SUNSHIELD INTEGRATED FLUSH-MOUNTED INTO THE SILL OF A SIDE LINING OF A MOTOR VEHICLE

(75) Inventors: Bernd Brendel, Kempen (DE); Gernot Beck, Sinsheim (DE); Josef Budke, Krefeld (DE)

Correspondence Address: FOLEY AND LARDNER LLP;SUITE 500, 3000 K STREET NW, WASHINGTON, DC, 20007, US

(73) Assignee: Johnson Controls Interiors GmbH

(21) Appl. No.: 12/095,257

(22) PCT Filed: Nov. 28, 2006
(86) PCT No.: PCT/EP2006/011408

§ 371 Date: Nov. 14, 2008

(30) Foreign Application Priority Data
Nov. 29, 2005 (DE) 10 2005 057 248.0

(51) Int. Cl. B60J 1/20

(52) U.S. Cl. 160/370.22

(57) ABSTRACT

The present invention relates to the side lining of a motor vehicle, which side lining has a sill (1), wherein a roller (2) is integrated flush-mounted into the sill (1).

The present invention relates to the side lining of a motor vehicle, which side lining has a sill, with a roller blind being integrated flush-mounted into the sill.

Roller blinds, by means of which it is possible for in particular the rear side windows of a motor vehicle to be covered for sun protection, are nowadays often installed in motor vehicles. Here, said roller blinds are generally seated at least partially on the sill of the lining for example of a side door, and therefore pose a safety risk in the event of an accident. Furthermore, the regions in which the roller blind is arranged are only accessible with difficulty for cleaning.

It was therefore the object of the present invention to provide a side lining which does not have the disadvantages of the prior art.

The object is achieved according to the invention by means of the side lining of a motor vehicle which has a sill in which a roller blind is integrated flush-mounted into the sill.

To a person skilled in the art, it was extremely astonishing and unexpected that the side lining according to the invention posed a significantly reduced safety risk in the event of an accident. Furthermore, the side lining is very easy to clean, such that the motor vehicle remains in an appealing visual state. The side lining according to the invention can be produced in a simple and cost-effective manner.

According to the invention, the side lining has a sill. Said sill is generally that part of the side lining which is adjoined by a window. According to the invention, a roller blind is integrated flush-mounted into said sill. Within the context of the invention, a side region means regions in which the body or the window surfaces run substantially vertically.

Within the context of the invention, flush-mounted means that the normally-resulting profile of the sill is not changed by the roller blind. The roller blind does not generate any shoulders, offsets or the like. Furthermore, no components of the roller blind project out of the sill.

In one preferred embodiment, the roller blind is sunk into a shaft. Said shaft is covered by a shaft faceplate, with said shaft faceplate running flush with the sill, that is to say not projecting out of the sill in any way. Furthermore, no handles or other components of the roller blind project out of the sill.

In one preferred embodiment of the present invention, only one joint is provided between the sill and the shaft faceplate, which considerably simplifies in particular the cleaning of the sill and gives an appealing overall visual impression.

The roller blind preferably has a pull rod on which a handle is arranged, by means of which handle the roller blind can be pulled up or lowered down. According to the invention, the pull rod and said handle are likewise mounted flush into the sill.

The side lining according to the invention preferably has a means with which the handle can be selectively raised such that it protrudes out of the surface of the sill and is thereby more readily accessible to the occupants of the motor vehicle when desired. Said means is preferably a pressure switch which pushes the handle upward, that is to say out of the surface of the sill, when pressure is temporarily applied to the handle.

The shaft faceplate and the roller blind preferably interact in such a way that the roller blind automatically opens the shaft faceplate and, when the roller blind is lowered, automatically closes the shaft faceplate.

The side lining according to the invention can be arranged anywhere in the side region of the motor vehicle. The side lining is however preferably a door lining, in particular of the doors in the rear region of the motor vehicle.

In one preferred embodiment, said doors have, above the side lining according to the invention, means into which the roller blind can be reversibly hooked for as long as the sun protection provided by the roller blind is desired.

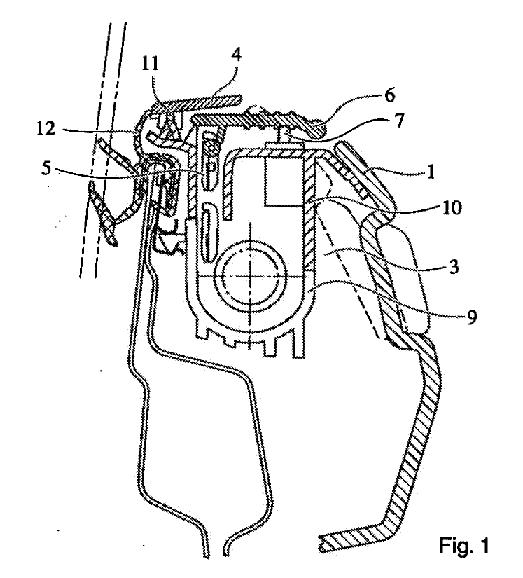

The invention is explained below on the basis of FIGS. 1 to 8. Said explanations are merely exemplary and do not restrict the general concept of the invention.

FIG. 1 shows a section through the side lining according to the invention,

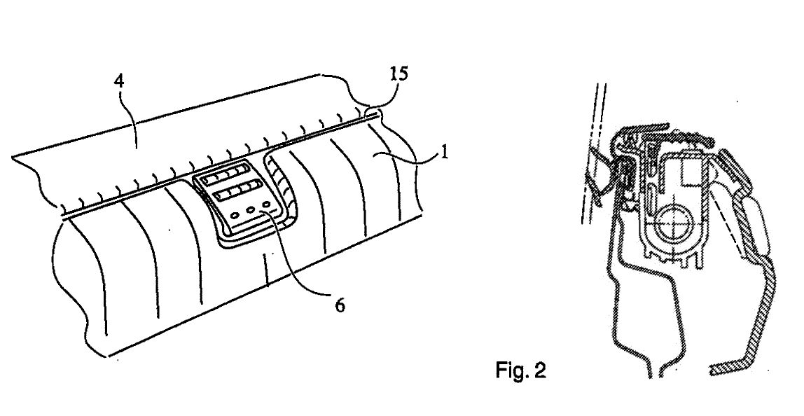

FIG. 2 shows the side lining according to the invention in a section and in a three-dimensional illustration in the closed state,

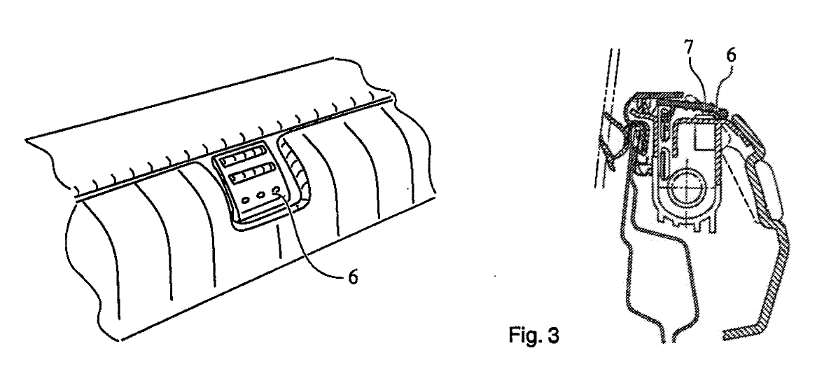

FIG. 3 shows the door lining as per FIG. 2 with the handle pressed down,

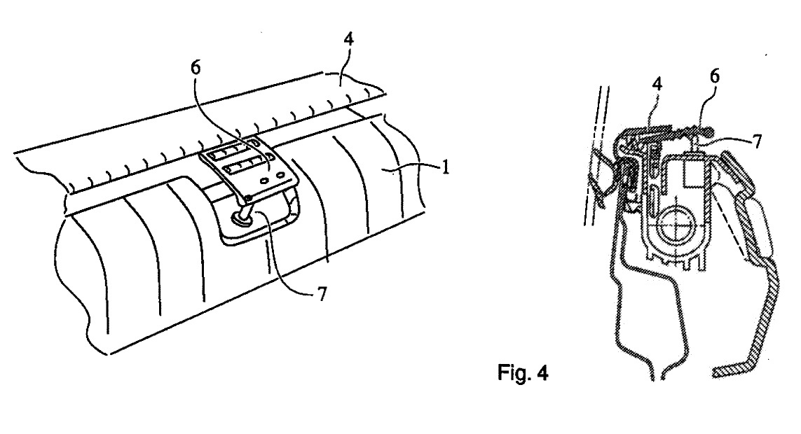

FIG. 4 shows the door lining as per the preceding figures with the handle raised,

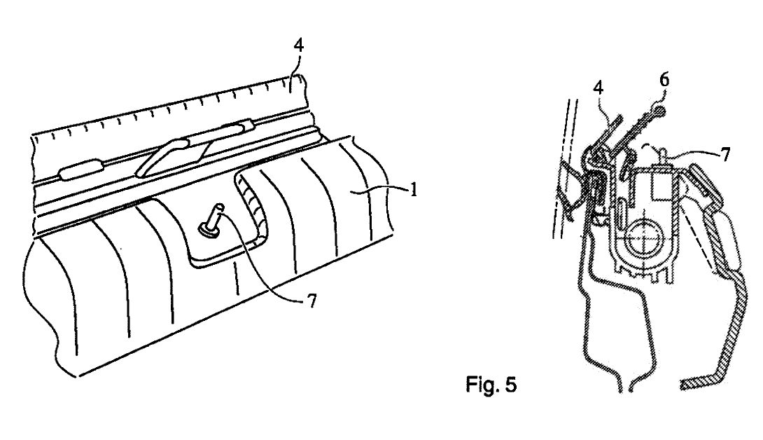

FIG. 5 shows the side lining according to the invention with the faceplate open,

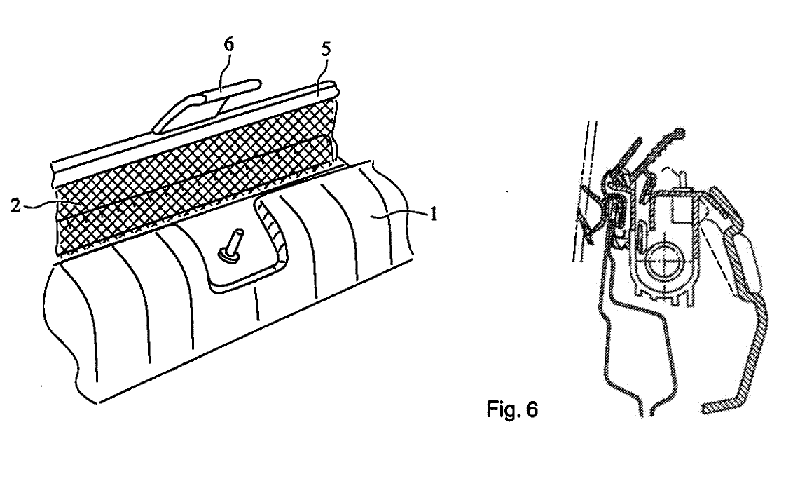

FIG. 6 shows the door lining according to the invention with the roller blind pulled out,

FIG. 7 shows the means for hooking-in the pull rod and

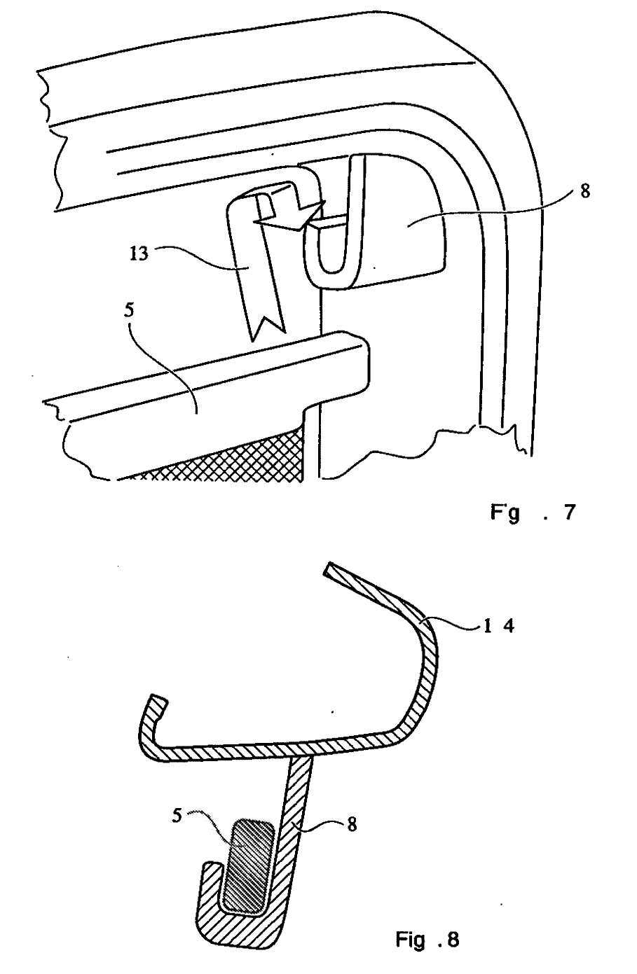

FIG. 8 shows the interaction of the pull rod with the hook-in means.

FIG. 1 illustrates the side lining according to the invention which has a sill 1 in its upper region. Situated below the sill 1 is a shaft 3 which is covered by a shaft cover 4 which is mounted so as to be rotatable about the bearing 11. The shaft cover 4 has, in its rear region, a seal 12 which serves to prevent dirt or moisture from passing into the space between the shaft cover and the body or the window. Arranged in the shaft 3 is a cassette 9 which is connected to the sill 1 by means of the connection 10. The roller blind (not illustrated) is situated in the sill 1. Arranged at the end of the roller blind is a pull rod 5 which has a rotatably mounted handle 6. In the closed state, that is to say in the state in which the shaft faceplate 4 completely covers the shaft 3, the handle 6 rests on a pressure switch 7 by means of which the handle 6 can be raised. In the closed state, the roller blind is integrated flush-mounted into the sill, that is to say neither the shaft cover 4 nor the handle 6 protrude out of the sill.

FIG. 2 shows, in the right-hand part, the section as per FIG. 1 and, in the left-hand part, a three-dimensional illustration of the side lining according to the invention, with only the sill 1 being illustrated. It can be clearly seen that the shaft cover 4 and the handle 6 run flush with the sill 1, that is to say neither the shaft cover 4 nor the handle 6 project out of the sill 1. Furthermore, it can be clearly seen that only one joint 15 is provided between the shaft cover 4 or the handle 6 and the sill 1, which considerably simplifies the cleaning of the sill. Because the shaft cover and the handle do not project out of the sill, the roller blind does not pose a safety risk in the event of an accident.

FIGS. 3 to 6 illustrate the unrolling of the roller blind. The first step illustrated in FIG. 3 involves the handle 6 being pushed downward and the means 7, a pressure switch, thereby being actuated. Once the pressure is no longer exerted on the handle 6, the pressure switch 7 pushes the handle 6 upward, such that the latter now protrudes out of the sill (cf. FIG. 4). Here, the shaft cover 4 is raised slightly. FIG. 5 shows the shaft cover 4 in the fully-open state. The handle 6 now protrudes distinctly out of the sill surface and can be easily gripped by the respective user and, as illustrated in FIG. 6, the roller blind can be pulled out of the shaft 3 by means of said handle 6.

Once the roller blind has been pulled substantially completely out of the shaft, the pull rod 5 can be hooked into the retaining device, as illustrated by arrow 13.

Said reversible hooking-in is illustrated once again in section in FIG. 8. In said illustration, it can be seen that the L-shaped retaining means 8 is arranged on a beam 14 of a door.

### LIST OF REFERENCE SYMBOLS

1 Sill
2 Roller blind
3 Shaft
4 Shaft cover
5 Pull rod
6 Handle
7 Lifting means of the handle, pressure switch
8 Hook-in means for the pull rod
9 Cassette in which the roller blind is situated
10 Connection of the cassette to the sill
11 Rotary bearing of the shaft cover
12 Seal between body and shaft cover
13 Arrow
14 Door beam

1. A side lining of a motor vehicle, which side lining has a sill, wherein a roller blind is integrated flush-mounted into the sill.

2. The side lining as claimed in claim 1, wherein the roller blind can be sunk into a shaft which is covered by a shaft faceplate, with the shaft faceplate running flush with the sill.

3. The side lining as claimed in claim 2, wherein the sill has only one joint.

4. The side lining as claimed in claim 1, wherein the roller blind has a pull rod with a handle which is mounted flush in the sill.

5. The side lining as claimed in claim 4, wherein said side lining has means which raises the handle.

6. The side lining as claimed in claim 2, wherein the shaft faceplate can be actuated in an automatically opening and closing manner by the roller blind.

7. The side lining as claimed in claim 1, wherein said side lining is part of a side door.

8. The side lining as claimed in claim 7, wherein the side door has means into which the roller blind can be hooked.
